(19) United States
(12) Patent Application Publication
(10) Pub. No.: US 2026/0100138 A1
(43) Pub. Date: Apr. 9, 2026

(54) METHODS AND SYSTEMS FOR PERSONALIZED ADAPTIVE AUDITORY TRAINING

(71) Applicant: Neurotone AI, Inc., Gainesville, FL (US)

(72) Inventors: Miles Aron, Austin, TX (US); Travis Whitton, Colares (PT); Rick Carlson, Gainesville, FL (US); Robert Sweetow, Half Moon Bay, CA (US); Jennifer Henderson Sabes, Bellevue, WA (US)

(21) Appl. No.: 19/327,703

(22) Filed: Sep. 12, 2025

Related U.S. Application Data
(60) Provisional application No. 63/704,822, filed on Oct. 8, 2024.

(51) Int. Cl. G09B 5/04; G10L 13/027; G10L 13/033; G10L 25/66

(52) U.S. Cl. CPC G09B 5/04; G10L 13/027; G10L 13/033; G10L 25/66

(57) ABSTRACT

The present disclosure relates to adaptive auditory training systems and methods. A synthesized audio representation of an input text is generated and presented to a first user during a training session. Audio input from the first user corresponding to the input text is received, and a difficulty level of the synthesized audio representation is dynamically adjusted between consecutive prompts based on quantitative performance metrics derived from the received audio input. Acoustic thresholds are defined by signal-to-noise ratio measurements and response accuracy ranges, and difficulty adjustments may include modifying parameters such as timing, background noise level, word similarity, pitch, syllable count, or context clues. The synthesized audio representation may be personalized by training an artificial intelligence model on voice samples of a second user to create an emotion-agnostic voice clone preserving that user's speech characteristics. Outputs may include audiology diagnostics and actionable insights for providers in audiology and speech pathology.

### CROSS-REFERENCE TO RELATED APPLICATIONS

This application claims priority to U.S. Application No. 63/704,822, titled METHODS AND SYSTEMS FOR PERSONALIZED ADAPTIVE AUDITORY TRAINING, filed Oct. 8, 2024, which is hereby incorporated by reference in its entirety.

### TECHNICAL FIELD

The present disclosure relates to computer-implemented methods and systems for adaptive auditory training, and more particularly to methods and systems that dynamically adjust training difficulty based on quantitative performance metrics derived from user responses, with real-time parameter modifications occurring between consecutive prompts during training sessions, and optional personalization features including voice cloning capabilities using artificial intelligence models.

### BACKGROUND

Hearing impairment is the inability of a listener to accurately understand sounds, particularly voices, in a variety of real-world environments. These environments often include background noise, distortions, and competing voices which make it difficult to hear what a particular speaker is saying. Additional factors may also adversely affect a listener's ability to accurately understand speech.

These factors can include the speed of the speaker, the similarity of neighboring words, the number of syllables in a word, the pitch of the speaker's voice, and context clues or the lack thereof in a sentence.

Auditory training is a systematic process aimed at improving an individual's ability to perceive and understand sounds, particularly speech, in various listening environments. This type of training is beneficial for individuals with hearing impairments, as it can enhance their ability to distinguish and comprehend speech in challenging auditory settings like noisy restaurants. Auditory training methods can include computer-based programs, live training sessions, and mobile applications that provide auditory training exercises designed to improve listening skills in various noise levels.

Components of auditory training may involve sound discrimination, where exercises help differentiate between various sounds, pitches, and volumes; speech recognition, where exercises help in identifying and understanding words and sentences; temporal processing, aimed at improving the ability to process the timing aspects of sounds for understanding speech rhythm and intonation; and spatial awareness, with exercises to help localize the source of sounds, aiding in focusing on a speaker in a noisy environment.

Current auditory training programs, however, can be ineffective for three reasons. First, users often quit the training program too quickly because they are not engaged by the training material or process. Second, a user's auditory training performance may not translate to real world performance because impersonal or repetitive training tasks can leave users feeling bored and frustrated, resulting in less time spent training. Third, existing systems lack the capability to determine optimal training difficulty thresholds for individual users and implement automated, dynamic, real-time difficulty adjustments to maintain performance within target parameters, despite evidence that training at maximum user capacity levels provides optimal learning outcomes and skill development.

Accordingly, there exists a need for improved methods and systems for more personalized and adaptive auditory training programs.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for performing adaptive auditory training is provided. The method comprises generating a synthesized audio representation of an input text, presenting the synthesized audio representation to a first user during an auditory training session, receiving audio input from the first user corresponding to the input text, and dynamically adjusting a difficulty of the synthesized audio representation based on quantitative performance metrics derived from the received audio input to maintain training difficulty within target performance parameters, wherein the adjustments occur between consecutive prompts during a same training session.

According to other aspects of the present disclosure, the method may include one or more of the following features. The method may further comprise personalizing the synthesized audio representation by training an artificial intelligence model on voice samples of a second user to create a voice clone of the second user that preserves speech characteristics of the second user, wherein the synthesized audio representation is emotion-agnostic with neutral prosody. Adjusting the difficulty may include modifying one or more audio parameters including at least one of a time between words, a background noise level, a similarity between neighboring words, a number of syllables in words, a pitch of words, and a number of context clues. The quantitative performance metrics may include at least one of QuickSIN SNR loss measurements, response latency data, signal-to-noise ratio measurements response accuracy ranges, and machine learning-generated performance scores. Dynamically adjusting the difficulty may further comprise evaluating user response accuracy after each prompt, calculating acoustic threshold parameters using a psychometric staircase algorithm, selecting a next training stimulus based on the psychometric staircase calculations, and implementing the selected stimulus before presenting a next prompt. The input text may be received from an interactive input text source comprising a chat session with an artificial intelligence chatbot, or from a dynamic input text source comprising at least one of a news feed and biblical passages. The method may further comprise generating, based on the dynamically adjusted difficulty synthesized audio representation, at least one of an audiology diagnostic and an actionable insight for providers in audiology and speech pathology. Dynamically adjusting the difficulty may comprise increasing a background noise level to simulate real-world listening environments. Presenting the synthesized audio representation to the first user may include combining a first audio stream comprising the synthesized audio representation with a second audio stream comprising generic background noise stored in a pre-curated noise library.

According to another aspect of the present disclosure, a system for adaptive auditory training is provided. The system comprises a processing unit and a memory operatively coupled to the processing unit. The system further comprises a text-to-speech module operable to generate a synthesized audio representation of an input text, a dynamic adjustment module operable to dynamically adjust a difficulty of the synthesized audio representation based on quantitative performance metrics derived from audio input received from a first user corresponding to the input text, to maintain training difficulty within target performance parameters, wherein the adjustments occur between consecutive prompts during a same training session, and a patient apps module operable to present the synthesized audio representation to the first user and receive the audio input from the first user.

According to other aspects of the present disclosure, the system may include one or more of the following features. The system may further comprise a personalization module operable to personalize the synthesized audio representation by training an artificial intelligence model on voice samples of a second user to create a voice clone of the second user that preserves speech characteristics of the second user, wherein the synthesized audio representation is emotion-agnostic with neutral prosody. Adjusting the difficulty may include modifying one or more audio parameters including at least one of a time between words, a background noise level, a similarity between neighboring words, a number of syllables in words, a pitch of words, and a number of context clues. The quantitative performance metrics may include at least one of QuickSIN SNR loss measurements, response latency data, signal-to-noise ratio measurements response accuracy ranges, and machine learning-generated performance scores. The dynamic adjustment module may be operable to evaluate user response accuracy after each prompt, calculate acoustic threshold parameters using a psychometric staircase algorithm, select a next training stimulus based on the psychometric staircase calculations, and implement the selected stimulus before presenting a next prompt. The input text may be received from an interactive input text source comprising a chat session with an artificial intelligence chatbot, or from a dynamic input text source comprising at least one of a news feed and biblical passages. The system may further comprise generating, based on the dynamically adjusted difficulty synthesized audio representation, at least one of an audiology diagnostic and an actionable insight for providers in audiology and speech pathology. Dynamically adjusting the difficulty may comprise increasing a background noise level to simulate real-world listening environments. The patient apps module may be operable to present the synthesized audio representation by combining a first audio stream comprising the synthesized audio representation with a second audio stream comprising generic background noise stored in a pre-curated noise library.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a flowchart for performing adaptive auditory training that provides concrete technological improvements to computer-based auditory training systems, in accordance with an aspect of the present disclosure;

FIG. 2 is a system diagram illustrating a computer system configured for performing personalized adaptive auditory training, in accordance with an aspect of the present disclosure;

FIG. 3 is a text-to-speech generative AI component diagram showing the voice cloning process, in accordance with an aspect of the present disclosure;

FIG. 4 is a user interface showing welcome screens of an auditory training program that incorporate an avatar, in accordance with an aspect of the present disclosure;

FIG. 5 is a user interface showing an Expert Communicator interface displaying a comprehensive gamification and achievement system with training categories and progress indicators, in accordance with an aspect of the present disclosure;

FIG. 6 is a user interface showing a rapid speech training interface featuring avatar-based instruction and user interaction elements, in accordance with an aspect of the present disclosure;

FIG. 7 is a user interface showing an auditory training interface with multiple choice answer interfaces for speech recognition testing, in accordance with an aspect of the present disclosure;

FIG. 8 is a training interface showing audio waveform visualization and user interaction elements, in accordance with an aspect of the present disclosure;

FIG. 9 is a user interface showing an auditory training interface with working memory exercise interfaces featuring restaurant scenario training, in accordance with an aspect of the present disclosure;

FIG. 10 is a user interface for choosing favorite topics in an auditory training application, in accordance with an aspect of the present disclosure;

FIG. 11 is a professional portal container diagram detailing the web application structure and supporting system interfaces, in accordance with an aspect of the present disclosure;

FIG. 12 is an administrative portal container diagram showing the admin system components and their relationships, in accordance with an aspect of the present disclosure;

FIG. 13 is a software architecture diagram showing hierarchical levels of system abstraction, in accordance with an aspect of the present disclosure;

FIG. 14 is a system context diagram showing the overall system interactions and architectural relationships between different user roles, system portals, and external service integrations, in accordance with an aspect of the present disclosure;

FIG. 15 is a patient apps container diagram showing relationships between user roles, system portals, and service components of an auditory training platform, in accordance with an aspect of the present disclosure;

FIG. 16 is a cloud-native backend component diagram, in accordance with an aspect of the present disclosure;

FIG. 17 is a single page web app component diagram, in accordance with an aspect of the present disclosure; and

FIG. 18 is a universal native app component diagram, in accordance with an aspect of the present disclosure.

### DETAILED DESCRIPTION

For purposes of this disclosure, the following terms have the meanings set forth below:

“Auditory training session” means a structured sequence of auditory tasks or prompts presented to a user for the purpose of improving speech perception, listening skills, or related cognitive-auditory functions.

“Synthesized audio representation” means an audio signal generated by a text-to-speech process that converts input text into spoken words, optionally including prosody, pitch, timing, and other speech characteristics.

“Quantitative performance metrics” means measurable values derived from the user's audio input, including but not limited to QuickSIN SNR loss measurements, response latency data, signal-to-noise ratio measurements response accuracy ranges, and machine learning-generated performance scores.

“Target performance parameters” means performance criteria established for training sessions that define acceptable ranges for user performance metrics to maintain training difficulty within specified bounds. The parameters serve as reference points for automated difficulty adjustment algorithms configured to modify one or more audio synthesis parameters when user performance deviates from the established parameters. In various embodiments, the term “target” may encompass predetermined criteria, the term “performance” may encompass acoustic performance characteristics, and the term “parameters” may encompass ranges, thresholds, or other measurable criteria.

“Dynamically adjusting” means automatically modifying one or more parameters in real time or near real time during or between prompts in a training session, based on quantitative performance metrics derived from user responses.

“Dynamic branching” means an algorithmic process that automatically selects subsequent training stimuli or exercise pathways from multiple available options based on real-time analysis of user performance metrics, where the selection process modifies training characteristics such as exercise type, content category, delivery methodology, or intervention protocol rather than adjusting parameters within a single exercise format. Dynamic branching encompasses decision tree algorithms that evaluate multiple performance factors simultaneously to determine optimal training progressions, pathway transitions between different training modalities, and adaptive selection mechanisms that coordinate with psychometric staircase algorithms to maintain target performance parameters.

“Audio parameters” means adjustable characteristics of a synthesized audio representation, including but not limited to a time between words, background noise level, similarity between neighboring words, number of syllables in words, pitch of words, and number of context clues.

“Psychometric staircase algorithm” means an adaptive testing procedure that iteratively modifies stimulus difficulty based on user performance to estimate a perceptual threshold efficiently, typically converging on a defined accuracy level.

“Voice clone” means a synthesized voice model trained on voice samples of a second user to preserve that user's speech characteristics. The voice clone is emotion-agnostic and exhibits neutral prosody.

“Interactive input text source” means a dynamically generated textual input obtained from an interactive medium, such as a chat session with an artificial intelligence chatbot, that provides real-time or responsive textual content for conversion to audio.

“Dynamic input text source” means a textual input obtained from a continuously updated source, such as a news feed or a database of biblical passages, that changes independently of user interaction.

“Audiology diagnostic” means a report or data set generated from user performance metrics during auditory training, configured to identify, quantify, or monitor auditory capabilities, hearing loss, or related conditions.

“Actionable insight” means a specific recommendation, adjustment, or intervention for a healthcare provider, derived from analysis of the user's auditory training performance and related metrics.

“Real-world listening environments” means acoustic conditions that simulate everyday auditory contexts, including background noise, competing speech, reverberation, or other environmental sound patterns.

“Generic background noise” means a pre-recorded or synthesized noise signal, stored in a pre-curated noise library, that is not derived from the current user's environment and is suitable for use in simulating real-world listening conditions.

“Pre-curated noise library” means a stored collection of background noise recordings selected and organized prior to training sessions for use in controlled auditory presentations.

As mentioned above, current computer-based auditory training systems suffer from technical limitations that prevent user engagement and training effectiveness. Many existing auditory training systems use simplistic binary assessment algorithms that categorize user responses as “correct” or “incorrect,” failing to capture the nuanced performance data for precise difficulty calibration.

Additionally, existing auditory training systems often lack parameter coordination capabilities for adjusting multiple audio characteristics simultaneously and, instead, modify single parameters (such as volume or background noise level) in isolation, failing to account for the complex interdependencies between different acoustic properties that affect speech comprehension difficulty. This limited approach results in suboptimal difficulty progression and reduced training effectiveness compared to systems capable of coordinated multi-parameter adjustment.

The present disclosure addresses these technical deficiencies through several technological improvements. The system incorporates quantitative performance analysis algorithms that extract metrics from user responses, including response latency patterns, error frequency distributions, and confidence indicators that may be derived through machine learning analysis. This quantitative approach provides more precise difficulty calibration compared to binary assessment systems, improving both system efficiency and training effectiveness.

Audio quality improvements are achieved through integration of neural speech synthesis technologies and voice cloning capabilities that preserve natural speaker characteristics. The system implements voice modeling algorithms that capture frequency patterns, formant distributions, and temporal dynamics of source speakers, generating natural-sounding synthetic speech that enhances user engagement and provides realistic training stimuli.

The disclosed system also implements coordinated multi-parameter adjustment algorithms that simultaneously modify multiple audio characteristics including temporal spacing, background noise integration, phonetic complexity, and prosodic variation while maintaining speech naturalness and intelligibility. This coordinated approach represents a technical advancement over single-parameter systems and provides more training progression that better matches individual user capabilities and learning requirements.

These technical improvements collectively address limitations in computer-based auditory training systems and provide measurable enhancements in processing efficiency, audio quality, and training effectiveness through algorithmic approaches and system architecture optimizations.

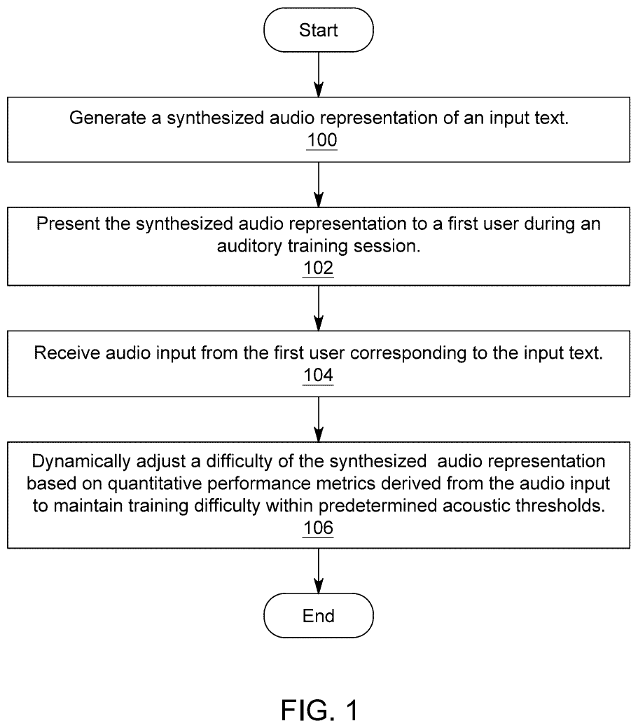

FIG. 1 illustrates a flowchart for performing adaptive auditory training according to various embodiments that provides technological improvements to computer-based auditory training systems. The method addresses the technical problem of maintaining optimal learning conditions in auditory training by implementing a computer-executed algorithm that automatically adjusts multiple audio processing parameters simultaneously based on measured user performance, thereby maximizing neuroplasticity and learning efficacy while preventing user frustration or habituation. The disclosed method provides technological improvements over conventional auditory training systems by using real-time adaptive difficulty algorithms that operate between consecutive prompts during the same training session and, optionally, also integrating voice cloning technology to enhance user engagement.

The method begins at step 100, which includes generating a synthesized audio representation of an input text. The synthesized audio representation may be created using artificial intelligence (AI) models that convert text input into acoustic waveforms. The AI model(s) may comprise a neural network architecture configured for high-quality speech synthesis, including an encoder network that converts text input into linguistic representations, an attention mechanism that aligns text elements with corresponding acoustic features, and a decoder network that generates mel-spectrograms representing target speech characteristics.

The speech synthesis process converts mel-spectrograms into raw audio waveforms while preserving natural speech characteristics including formant frequencies, pitch patterns, and articulatory timing. The system also implements computational optimizations such as parallel processing algorithms and memory-efficient model architectures that provide real-time audio generation with processing latency maintained below predetermined thresholds for interactive training applications.

The synthesized audio representation can include either a default system voice or a personalized voice. Both the default system voice and the personalized voice clone is emotion-agnostic with neutral prosody to avoid distorting the auditory training. Personalizing the synthesized audio representation may include training an artificial intelligence model on voice samples of, for example, a friend or family member of the user, to create a voice clone of them that preserves their speech characteristics. The voice cloning process may implement speaker adaptation algorithms that fine-tune the base AI model using the second user's voice samples to capture distinctive vocal characteristics including frequency patterns, spectral envelope characteristics, and temporal speech dynamics. The personalization process implements quality assurance algorithms that validate the fidelity of the voice clone against original voice samples using objective metrics including mel-cepstral distortion and perceptual evaluation measures.

The method proceeds to step 102, which includes presenting the personalized synthesized audio representation to a first user during an auditory training session. Audio processing algorithms may compensate for individual hearing loss characteristics by applying frequency-specific amplification, dynamic range compression, and noise reduction tailored to the first user's audiometric profile. The presentation of the personalized synthesized audio representation may be coordinated with device-specific output optimization to provide consistent audio quality across different playback hardware including hearing aids, headphones, and speakers.

The presentation timing of the personalized synthesized audio representation may be controlled by session management algorithms that coordinate audio playback with visual interface elements, user interaction monitoring, and response collection mechanisms to create synchronized multimedia training experiences.

At step 104, the method includes receiving audio input from the first user corresponding to the input text using speech recognition and response analysis systems. An audio input collection system may implement noise-robust speech recognition algorithms that process user vocal responses while filtering background interference and compensating for speech variations associated with hearing impairment. The system captures both verbal repetition attempts and user interaction responses including button selections, gesture inputs, and timing measurements that indicate comprehension accuracy and processing difficulty.

Response analysis algorithms extract quantitative performance metrics from the received audio input including pronunciation accuracy, response timing, hesitation patterns, and completion rates that provide quantitative measures of user comprehension and processing capability.

Finally, at step 106, the method includes dynamically adjusting the difficulty of the synthesized audio based on quantitative performance metrics derived from the user's audio responses, keeping performance within the target range. Adjustments may occur between consecutive prompts in the same session, enabling real-time adaptation. The system may concurrently modify multiple audio parameters, including prosodic timing (time between words), background noise level, phonetic similarity between neighboring words, lexical complexity (number of syllables), pitch characteristics, and the density of context clues in the semantic content.

Difficulty control may use psychometric staircase algorithms that compare response accuracy to predetermined acoustic thresholds defined by signal-to-noise ratio measurements and accuracy bands. When performance exceeds the upper threshold, difficulty may be increased by reducing word spacing, raising background noise, or selecting more phonetically similar words. When performance falls below the lower threshold, the system may apply the inverse modifications. Coordinated, multi-parameter changes limit gaming strategies and preserve challenge levels that support neuroplasticity and skill acquisition.

In addition to parameter tuning, the system performs dynamic branching to select training pathways in real time. Using decision-tree logic over accuracy, response latency, and tolerance indicators, the system transitions among exercise types, content categories, and intervention protocols. Dynamic branching operates in concert with the staircase algorithms so that pathway shifts maintain calibrated difficulty progression.

A staircase controller may track independent trajectories for key dimensions (such as signal-to-noise ratio, speech rate, phonetic complexity, and contextual predictability) while using a parameter-interaction matrix to model nonlinear couplings among these dimensions. Using such a matrix may improve difficulty predictions in a multidimensional space and prevents suboptimal results that would arise from treating parameters as independent.

Step sizes may follow a geometric-decrease schedule after each performance reversal to speed convergence while avoiding overshoot. Initial steps span the expected range (typically two to four just-noticeable differences for the relevant parameter). After a reversal, the step size reduces by a predetermined factor to refine threshold estimates and minimize oscillation around the target level.

Weighted staircase procedures, including n-up/m-down rules, target specific convergence points determined by established psychophysical equations, aligning thresholds with auditory-training objectives. To further stabilize behavior near boundaries, a hysteresis rule requires performance to exceed criteria for a set number of consecutive trials before applying a difficulty change.

Adaptation may occur on two timescales. Local adaptation may respond to in-session fluctuations with short time constants, while global adaptation may track learning trends across sessions with longer time constants. Together, calibrated difficulty may be maintained from moment to moment and across the training program.

Throughout operation, the system may also record diagnostic data on response patterns and effective parameter settings. These data support clinical assessment and help refine treatment planning.

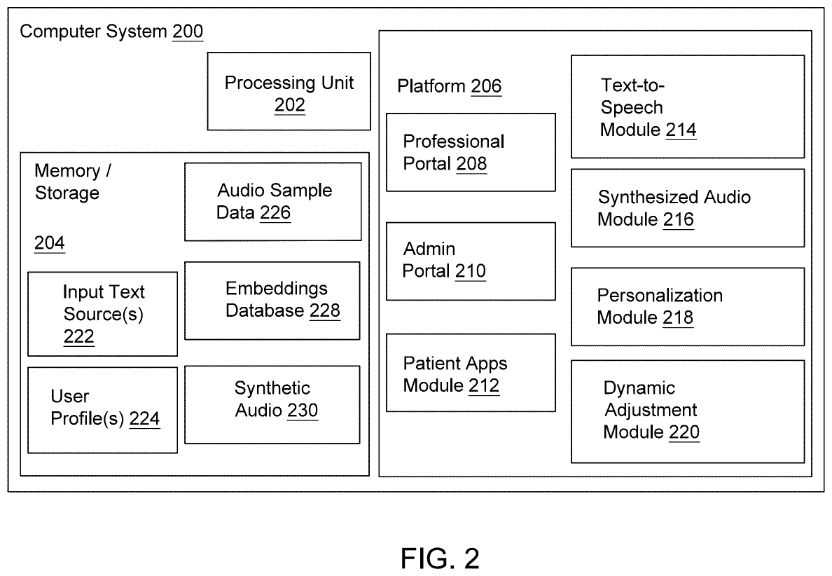

FIG. 2 illustrates a computer system 200 configured for performing personalized adaptive auditory training according to various embodiments. Computer system 200 provides the foundational infrastructure for implementing the auditory training methods and processes described herein. The computer system 200 includes a processing unit 202 that serves as the central computational component for executing the various algorithms and processes involved in generating, personalizing, and dynamically adjusting synthesized audio representations. The processing unit 202 comprises one or more processors capable of executing software instructions and performing the complex calculations involved in artificial intelligence model operations, voice cloning, and real-time audio processing.

The computer system 200 includes memory storage 204 operatively coupled to the processing unit 202. The memory storage 204 provides data storage capabilities including volatile memory such as RAM for temporary data storage during processing operations, as well as non-volatile memory such as solid-state drives for long-term data retention. The memory storage 204 stores voice samples, training datasets, user profiles, and generated audio content that support the auditory training functionality.

The computer system 200 incorporates platform 206 that serves as the central software framework for coordinating and managing the various components and services. The platform 206 may be implemented to deliver services with real-time capabilities. The platform 206 coordinates the interaction between modules and provides the underlying infrastructure for data management, user authentication, and service delivery.

The platform 206 includes a professional portal 208 that provides comprehensive functionality for hearing care professionals including patient billing capabilities, patient progress tracking functionality, team member management features, support functionality, notification systems, and reporting features that generate detailed analytics and performance summaries for clinical assessment.

The platform 206 incorporates an admin portal 210 that provides administrative functionality for system management including practice creation capabilities, clinic creation functionality, banding customization features, billing platform management tools, revenue tracking capabilities, content curation functionality, and integration capabilities that enable connectivity with third-party content providers.

The platform 206 includes a patient apps module 212 that delivers user-facing functionality accessible via mobile devices and web interfaces. The patient apps module 212 provides localization support, customizable themes, voice cloning capabilities, comprehensive training functionality, assessment tools, progress indicators, content feed features, user settings functionality, appointment booking capabilities, sound therapy features, and notification systems.

The platform 206 also includes specialized audio processing modules that handle the technical aspects of voice synthesis and personalization, such as a text-to-speech module 214 that generates synthesized audio representations of input text using artificial intelligence models. The text-to-speech module 214 may use neural network-based approaches such as WaveNet, Tacotron, or WaveGlow for high-quality speech synthesis that produces natural-sounding audio output using either default system voices or personalized voice clones when available.

A synthesized audio module 216 may work in conjunction with the text-to-speech module 214 to generate and manage synthesized audio content. The synthesized audio module 216 coordinates audio generation processes and manages audio output, including both default system voices and personalized voice clones when available. The synthesized audio module 216 handles audio file management, quality control, and delivery of synthesized speech content to training applications regardless of whether default voices or personalized voice clones are utilized.

A personalization module 218 provides optional personalization of the synthesized audio representation through voice cloning capabilities. When voice cloning is enabled, the personalization module 218 creates a voice clone that preserves speech characteristics unique to a selected speaker by collecting high-quality voice data, preprocessing the data to remove noise and normalize audio characteristics, training deep learning models on the processed voice samples, and fine-tuning the models for accuracy and naturalness. When voice cloning is not utilized, the system operates with default system voices. The personalization module 218 may also select input text sources based on user preferences including favorite Bible passages, sports radio, or ChatGPT to provide personalized audio training experiences.

A dynamic adjustment module 220 dynamically adjusts the difficulty of synthesized audio representations based on feedback from users during auditory training sessions to optimize user engagement and performance. The dynamic adjustment module 220 modifies at least one of a time between words, a background noise level, a similarity between neighboring words, a number of syllables in words, a pitch of words, and a number of context clues to create appropriate challenge levels for individual users. The dynamic adjustment module 220 generates new diagnostics and actionable insights for providers in audiology and speech pathology by measuring analytic elements of speech in-context.

The memory storage 204 incorporates specialized data storage components including input text sources 222 that store various types of textual content, user profiles 224 that store comprehensive information about individual users, audio sample data 226 that contains voice recordings for voice cloning operations, embeddings database 228 that stores high-dimensional vector representations of linguistic elements, and synthetic audio 230 that stores generated audio content from the voice cloning and speech synthesis processes.

It may be appreciated that the disclosed computer system 200 may implement a distributed computational architecture where discrete functional modules operate asynchronously to provide measurable improvements in system performance, security, and scalability metrics compared to conventional monolithic auditory training implementations.

The computer system 200 may, in some embodiments, include a remote voice capture module that may generate cryptographically secure, time-limited authentication tokens for third-party voice sample collection. The remote voice capture module may operate independently from primary training.

A quarantine storage subsystem (not shown) may also be provided for temporary isolation of biometric voice data during processing operations. The quarantine storage subsystem may implement automated quality assurance protocols that may include signal-to-noise ratio validation exceeding predetermined thresholds, temporal duration verification protocols, and voice consistency analysis utilizing biometric verification algorithms. The quarantine storage subsystem may prevent contamination of primary system databases with unvalidated voice data while enabling comprehensive quality assessment before voice model generation.

The system may further include a vendor-agnostic voice synthesis interface that may implement standardized API protocols for communication with multiple third-party voice synthesis services. The interface may maintain abstraction layers that may enable dynamic service provider selection based on predetermined criteria that may include availability metrics, quality scores, and cost parameters. This vendor-agnostic approach may provide system resilience and may prevent dependence on single voice synthesis providers.

A content delivery network configuration may be implemented where voice model identifiers, which may typically comprise a small amount of parametric data (e.g., one to two kilobytes), may be stored instead of pre-generated audio files. Runtime stimulus generation may occur through dynamic combination of stored identifiers with selected textual content and acoustic parameters. The runtime stimulus generation engine may implement just-in-time audio synthesis protocols that may combine voice model parameters, textual input, and difficulty specifications to generate training stimuli with sub-second latency while minimizing storage requirements.

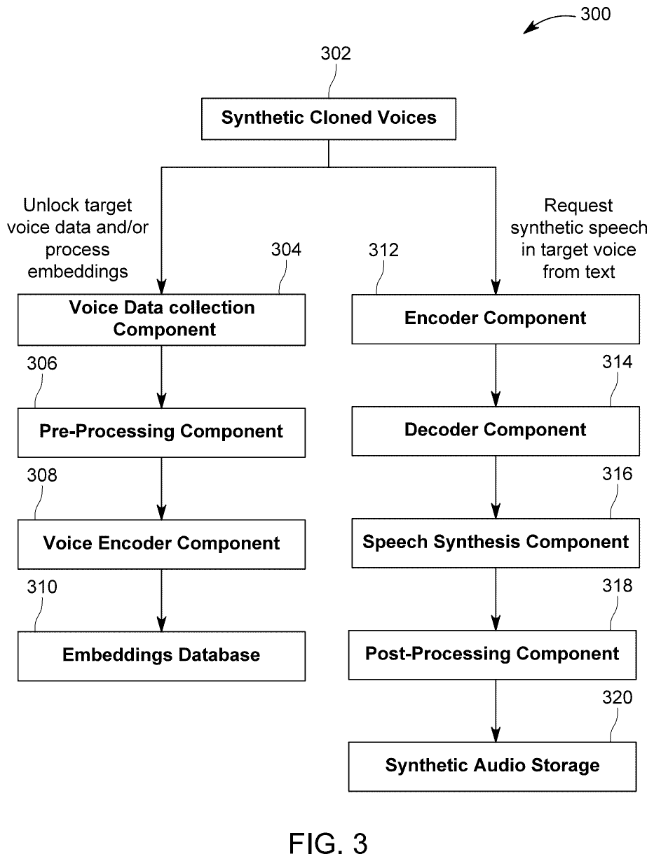

FIG. 3 illustrates a text-to-speech generative AI component diagram showing the voice cloning process according to various embodiments. The diagram presents a comprehensive architecture for generating synthetic speech using voice cloning technology, with components organized into two primary processing paths that work together to create personalized audio representations. The architecture demonstrates how voice data collection and processing operations integrate with speech synthesis and output generation to produce high-quality synthesized audio that preserves the speech characteristics unique to individual speakers.

The left path focuses on voice data collection and processing operations that form the foundation for creating accurate voice clones. A voice data collection component 304 initiates the process by gathering high-quality voice recordings from the individual whose voice is to be cloned, capturing a comprehensive range of phonetic variations, intonations, and emotional expressions that characterize the speaker's unique vocal patterns. The voice data collection component 304 may obtain recordings through structured reading sessions, conversational recordings, and emotional expression samples that demonstrate the speaker's vocal range across different contexts and moods.

A pre-processing component 306 receives the raw voice data and performs various operations to prepare the audio for model training. The pre-processing component 306 implements noise reduction algorithms to eliminate background interference, segmentation procedures to divide recordings into manageable chunks for analysis, and normalization processes to ensure consistent volume levels and audio characteristics across all voice samples. The pre-processing component 306 also performs text preprocessing operations including expanding abbreviations, converting numbers to words, and correcting grammatical errors before phonetic transcription occurs.

A voice encoder component 308 processes the preprocessed audio data to extract meaningful features that represent the speaker's vocal characteristics. The voice encoder component 308 utilizes deep learning architectures such as convolutional neural networks or recurrent neural networks to analyze spectral features, temporal patterns, and acoustic properties that define the speaker's voice. The voice encoder component 308 generates feature vectors that capture phonetic information, prosodic patterns, and speaker-specific characteristics including vocal tract resonances, fundamental frequency patterns, and articulatory habits.

An embeddings database component 310 stores the processed voice features and associated metadata generated by the voice encoder component 308. The embeddings database component 310 maintains high-dimensional vector representations that encapsulate the acoustic and linguistic properties of the speaker's voice, enabling efficient retrieval and utilization during speech synthesis operations.

The right path handles speech synthesis and output generation operations that transform text input into synthesized audio using the processed voice characteristics. An encoder component 312 receives input text and converts the textual information into intermediate representations suitable for speech synthesis processing. The encoder component 312 performs linguistic analysis to determine syntactic structures, semantic relationships, and contextual information that influence pronunciation, stress patterns, and intonation contours in the generated speech.

A decoder component 314 transforms the encoded text representations into acoustic features using the voice characteristics stored in the embeddings database component 310. The decoder component 314 employs neural network-based approaches for speech synthesis that produces natural-sounding audio output. The decoder component 314 integrates the target voice embeddings with the text-derived features to generate mel-spectrograms, acoustic parameters, or other intermediate representations that capture both the linguistic content and the speaker-specific vocal characteristics.

A speech synthesis component 316 converts the acoustic features generated by the decoder component 314 into final audio waveforms that represent the synthesized speech. The speech synthesis component 316 utilizes vocoder technologies, neural audio generation models, or hybrid synthesis approaches that combine multiple techniques to achieve high-quality audio output.

A post-processing component 318 refines the synthesized audio output to enhance naturalness, clarity, and overall quality of the generated speech. The post-processing component 318 applies audio enhancement techniques including equalization, dynamic range compression, and noise reduction to eliminate synthesis artifacts.

A synthetic audio storage component 320 maintains the final synthesized audio output along with associated metadata and processing parameters, organizing generated audio files according to content categories, difficulty levels, or user-specific parameters that facilitate efficient retrieval during training sessions.

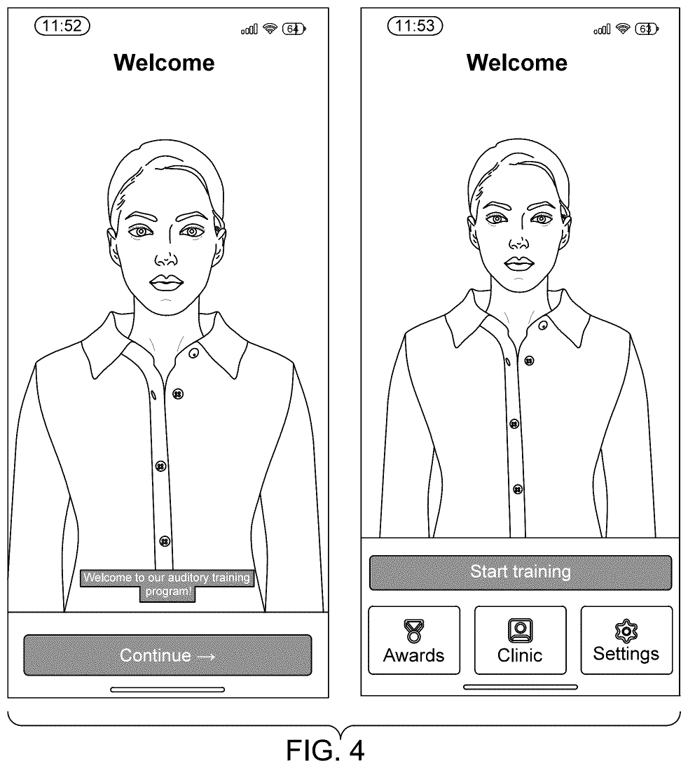

FIG. 4 illustrates user interface welcome screens of the auditory training program according to various embodiments. The welcome screens provide the initial user interaction point for accessing personalized adaptive auditory training functionality through the patient apps module 212. The welcome screens incorporate synthetic human-like video media technology that allows patients to learn from human-like avatars with realistic facial gestures and lip movements for lip-reading training. The avatar presentation within the welcome screens establishes a visual connection between users and the training system, creating an engaging entry point that encourages participation in auditory training exercises.

The left welcome screen displays an avatar providing a professional and approachable visual representation for users beginning their training sessions (e.g., wearing a light blue button-down shirt positioned against a dark background). The avatar incorporates realistic facial features, natural expressions, and lifelike appearance characteristics that enhance user comfort and engagement during initial system interactions. A continue button appears at the bottom of the left welcome screen, enabling users who have previously interacted with the patient apps module 212 to resume their training progress from previous sessions.

The right welcome screen presents the same avatar configuration while offering expanded navigation options for users to access different areas of the auditory training system. Three selectable options appear at the bottom including Awards, Clinic, and Settings, each providing access to distinct functionality areas within the patient apps module 212. The Awards option enables users to view achievement progress and gamification elements. The Clinic option provides access to healthcare provider information and appointment scheduling functionality. The Settings option allows users to customize their training experience and adjust audio parameters.

The welcome screens serve as the primary interface for presenting the personalized synthesized audio representation to a second user during an auditory training session through the patient apps module 212. The avatar presentation utilizes the synthetic human-like video media technology to display realistic facial gestures and lip movements that correspond to synthesized speech output generated by the text-to-speech module 214, creating synchronized audiovisual experiences that support both auditory comprehension and visual speech recognition training.

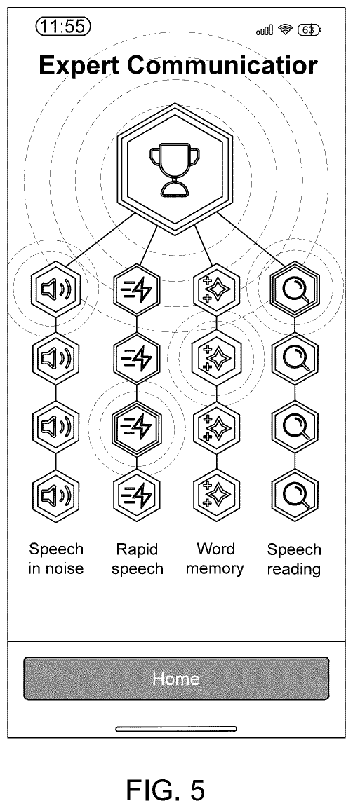

FIG. 5 illustrates an Expert Communicator interface displaying a comprehensive gamification and achievement system according to various embodiments. It should be appreciated that the Expert Communicator interface is just one way to engage the user, among several, and is intended to be illustrative of gamification but does not define or limit the scope of the subject matter disclosed herein. The Expert Communicator interface demonstrates how the patient apps module 212 implements motivational elements and progress tracking functionality that enhance user engagement through structured achievement recognition and visual progress feedback mechanisms. The interface incorporates a trophy icon positioned at the top of the screen, symbolizing the ultimate achievement goal that users may attain through successful completion of training activities across multiple skill areas.

The Expert Communicator interface displays four distinct training categories arranged in vertical columns beneath the trophy icon: Speech in Noise, Rapid Speech, Working Memory, and Speech Reading training areas that correspond to different aspects of auditory processing and communication skill development. Each training category represents specialized functionality areas that address specific auditory challenges and skill development objectives through targeted exercise sequences and progressive difficulty adjustments.

Each training category contains multiple progress indicators arranged vertically that represent different stages of completion, achievement levels, or skill development milestones within specific training domains. The hexagonal progress indicators utilize different colors to indicate various completion states, achievement status levels, or performance quality ratings that provide users with immediate visual feedback about their training progress and accomplishment recognition. The patient apps module 212 coordinates the color coding of progress indicators with user performance data, accuracy measurements, and completion rates to create meaningful visual representations of achievement status that motivate continued participation and skill development efforts.

The gamification system implemented through the Expert Communicator interface provides awards that users unlock as they progress through four increasing levels of difficulty in the four testing areas. The patient apps module 212 tracks user performance across multiple training sessions and automatically unlocks achievement awards when users demonstrate sustained improvement, reach accuracy thresholds, or complete specified training milestones within each skill category. The award system incorporates multiple recognition levels within each training category, enabling users to earn progressive achievements that acknowledge incremental improvement and sustained effort.

The Expert Communicator achievement system culminates in a comprehensive recognition award that users may earn through successful completion of training activities across all four skill categories, demonstrating mastery of diverse auditory processing and communication capabilities.

The interface includes a Home button positioned at the bottom that enables navigation back to primary system functionality while maintaining achievement progress and training status information.

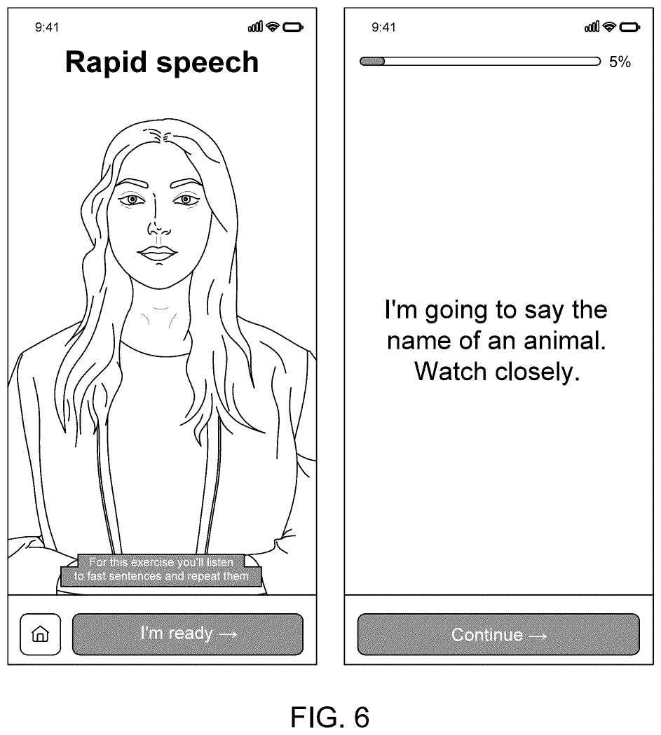

FIG. 6 illustrates rapid speech training interface screens featuring avatar-based instruction and user interaction elements according to various embodiments. The rapid speech training screens demonstrate how the patient apps module 212 implements specialized training exercises that test users'ability to comprehend fast speech through personalized difficulty adjustments managed by the dynamic adjustment module 220. The interface screens incorporate synthetic human-like video media technology that allows patients to learn from human-like avatars with realistic facial gestures and lip movements for lip-reading training.

The left rapid speech training screen displays an instructor avatar positioned against a dark background, providing users with visual instruction and guidance for rapid speech comprehension exercises. The avatar utilizes the synthetic human-like video media technology to display dynamic facial expressions, eye contact patterns, and synchronized lip movements that correspond precisely to the synthesized speech output generated by the text-to-speech module 214. Text content indicates that users will listen to fast sentences and repeat them, establishing clear expectations for the training exercise format.

The right rapid speech training screen presents contextual information through text display, stating “I'm going to say the name of an animal. Watch closely,” providing users with specific context about the upcoming training material and encouraging focused attention on both auditory and visual elements. The progress indicator showing 5% completion demonstrates how the system tracks user advancement through rapid speech training exercises.

The rapid speech training functionality enables the dynamic adjustment module 220 to dynamically adjust difficulty by modifying the time between words in the synthesized speech output to create varying levels of processing challenge. The modification of time between words involves precise temporal adjustments that accommodate individual user capabilities and learning progression requirements. The patient apps module 212 collects user response data, accuracy measurements, and completion times that inform the dynamic adjustment module 220 about appropriate timing modifications for subsequent training exercises.

The dynamic adjustment module 220 may also modify background noise levels during rapid speech training exercises to simulate real-world listening environments and create additional comprehension challenges. Background noise modifications may include competing voices, environmental sounds, or acoustic interference patterns that require users to focus attention on target speech signals while filtering out distracting auditory information.

The rapid speech training may incorporate modifications to the similarity between neighboring words within training sentences, creating phonetic challenges that test users'ability to distinguish between acoustically similar speech elements during rapid presentation conditions. The dynamic adjustment module 220 may also modify the number of syllables in words and pitch characteristics to create varying levels of complexity that influence processing demands and comprehension difficulty levels.

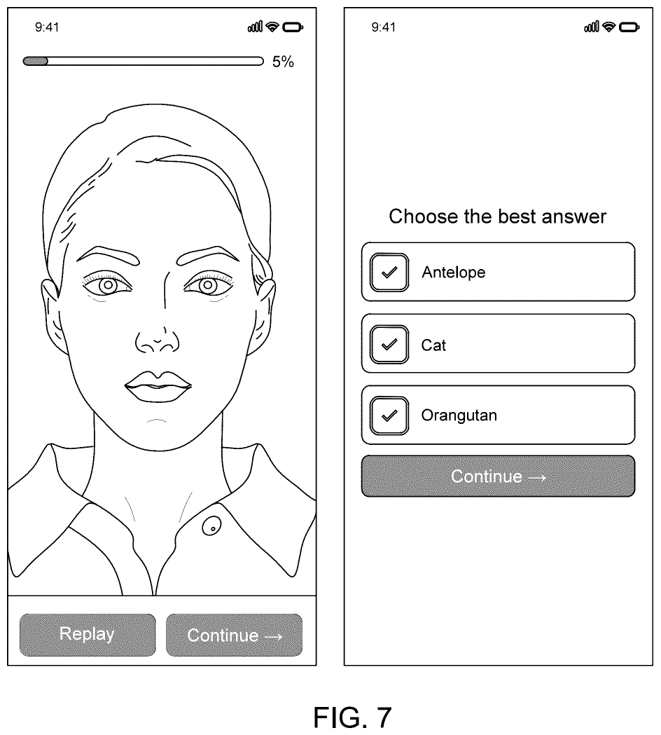

FIG. 7 illustrates auditory training screens with multiple choice answer interfaces for speech recognition testing according to various embodiments. The multiple choice answer interface screens demonstrate how the patient apps module 212 implements comprehensive assessment functionality that combines avatar-based speech presentation with structured response collection mechanisms to evaluate user comprehension accuracy and inform training progression decisions.

The left assessment screen displays an avatar presented against a dark background with interface controls that enable users to interact with the speech recognition testing functionality. The avatar presentation utilizes the synthetic human-like video media technology to generate lifelike facial movements and natural lip synchronization patterns that correspond precisely to the synthesized speech output generated by the text-to-speech module 214. The patient apps module 212 presents the personalized synthesized audio representation to the second user through the avatar interface, delivering speech content that incorporates voice cloning characteristics from familiar speakers.

The interface controls include a replay button that enables users to request repeated presentation of the speech content, accommodating individual processing needs and ensuring that assessment results reflect comprehension abilities rather than memory limitations. A continue button allows users to proceed to the response selection phase after processing the presented speech content. The progress indicator showing 5% completion demonstrates session tracking functionality.

The right assessment screen presents a multiple choice answer interface with the prompt “Choose the best answer” followed by three selectable response options: “Antelope,” “Cat,” and “Orangutan.” The patient apps module 212 receives audio input from the second user corresponding to the input text through the multiple choice selection mechanism, enabling users to demonstrate their comprehension of the speech content presented through the avatar interface.

The multiple choice answer options are strategically selected to test specific aspects of auditory discrimination and speech recognition capabilities, including phonetic similarity challenges, semantic category relationships, and acoustic confusion patterns that provide diagnostic information about user comprehension strengths and areas for improvement. The selection of animal names as response options reflects category consistency while incorporating varying syllabic complexity, phonetic characteristics, and acoustic properties that create meaningful assessment challenges.

The patient apps module 212 utilizes the multiple choice interface to collect detailed response data that informs training progression decisions and provides healthcare professionals with diagnostic information about user performance patterns.

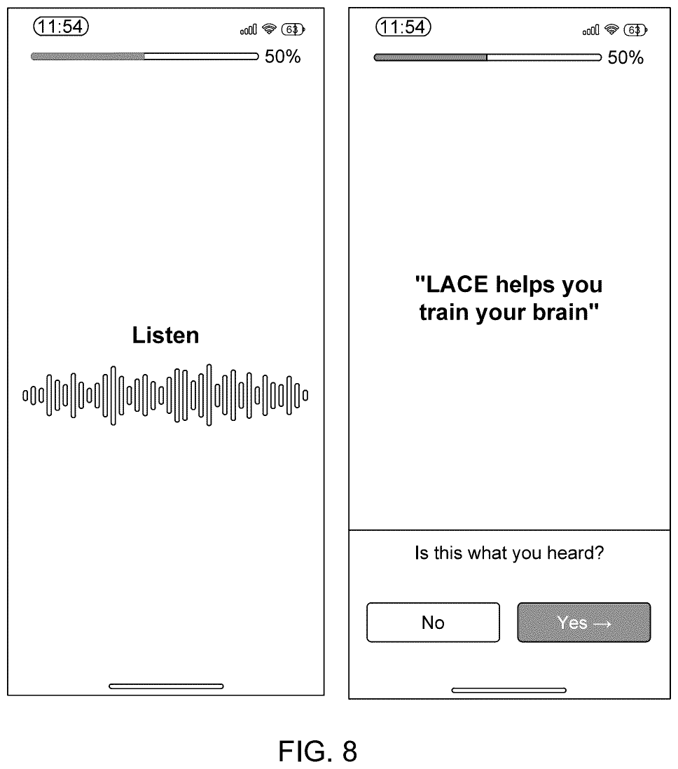

FIG. 8 illustrates training interface screens showing audio waveform visualization and user interaction elements according to various embodiments. The training interface screens demonstrate how the patient apps module 212 presents the personalized synthesized audio representation to a second user during an auditory training session while providing visual feedback and interaction mechanisms that support effective learning outcomes.

The left training interface screen displays a colorful audio waveform visualization against a gradient background, providing real-time visual representation of the synthesized audio content. The waveform visualization incorporates multiple colors and dynamic patterns corresponding to different acoustic properties of the synthesized speech, including amplitude variations, frequency content, and temporal characteristics. The patient apps module 212 generates the waveform visualization by analyzing the personalized synthesized audio representation in real-time, extracting spectral features and amplitude envelopes that create meaningful visual feedback during training sessions.

The right training interface screen presents text content corresponding to the synthesized audio representation, displaying “LACE helps you train your brain” along with user interaction elements for response collection. The text display shows the actual content of the input text used to generate the personalized synthesized audio representation, enabling users to compare their auditory comprehension with the written content.

The response interface includes the question prompt “Is this what you heard?” followed by “No” and “Yes” response buttons that enable the patient apps module 212 to receive audio input from the second user corresponding to the input text. These interaction elements provide mechanisms for users to confirm their understanding and provide feedback about their auditory comprehension accuracy. The patient apps module 212 utilizes the user responses to assess comprehension accuracy, track learning progress, and inform the dynamic adjustment module 220 about user performance levels that influence future training parameter modifications.

Both training interface screens include progress indicators showing 50% completion status, demonstrating how the patient apps module 212 tracks user advancement through training sessions and provides visual feedback about session progress and remaining content. The progress indicators may reflect completed exercises, time spent in training, accuracy levels achieved, and milestone accomplishments that contribute to overall training progress assessment.

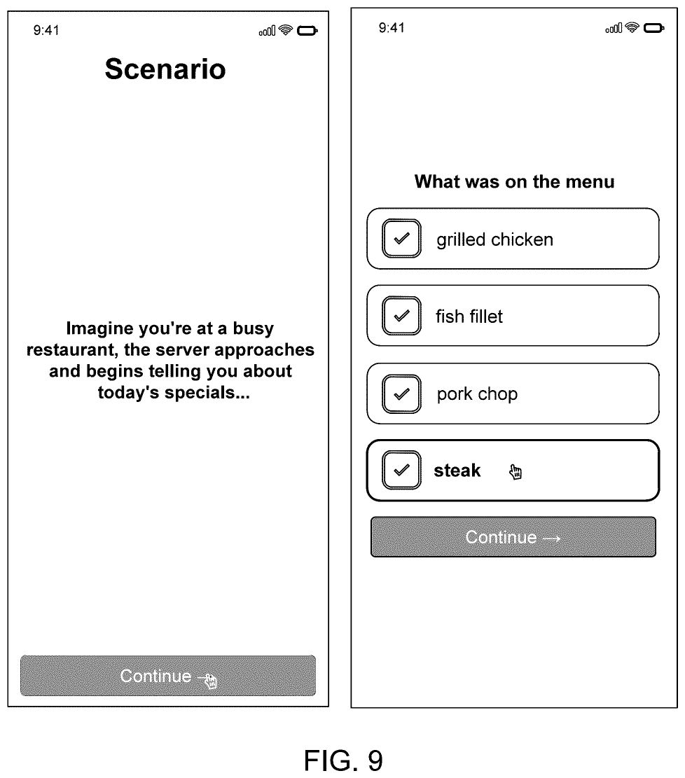

FIG. 9 illustrates auditory training screens with working memory exercise interfaces featuring restaurant scenario training according to various embodiments. The working memory exercise screens demonstrate how the patient apps module 212 implements specialized cognitive training functionality that tests users'ability to retain and recall details from longer or more complex auditory passages during realistic listening scenarios.

The left working memory training screen presents scenario setup information establishing the contextual framework for the upcoming auditory exercise. The text content states “Imagine you're at a busy restaurant, the server approaches and begins telling you about today's specials . . . ” providing users with advance preparation about the listening scenario and the type of information they may be expected to remember during the exercise. The patient apps module 212 utilizes contextual preparation approaches to enhance user readiness for complex auditory processing tasks by providing advance organizers that help users focus their attention on relevant information categories.

The restaurant scenario training presents the personalized synthesized audio representation to the second user by delivering synthesized speech content that simulates a waiter describing menu items, daily specials, preparation methods, or pricing information in a realistic conversational context. The synthesized audio content incorporates voice cloning characteristics generated by the personalization module 218 to create familiar speaker presentations that enhance user engagement while delivering complex auditory information that challenges working memory capabilities. The patient apps module 212 may coordinate the presentation with background noise simulation, competing conversation elements, or environmental sound effects that replicate the acoustic challenges users encounter in actual restaurant environments.

The right working memory training screen displays a menu selection interface with the question “What was on the menu” followed by four selectable response options including grilled chicken, fish fillet, pork chop, and steak. The patient apps module 212 receives audio input from the second user through the multiple choice selection mechanism, enabling users to demonstrate their retention and recall of specific auditory information presented during the restaurant scenario exercise. The response collection functionality tests users'ability to distinguish between items that were mentioned during the auditory presentation versus distractor options that were not included in the original speech content.

The working memory exercise functionality incorporates varying levels of cognitive challenge by modifying the length and complexity of auditory passages presented during restaurant scenario training sessions. The dynamic adjustment module 220 analyzes user performance patterns during working memory exercises and modifies future training content to provide appropriate cognitive load levels that promote memory skill development without overwhelming user processing capabilities.

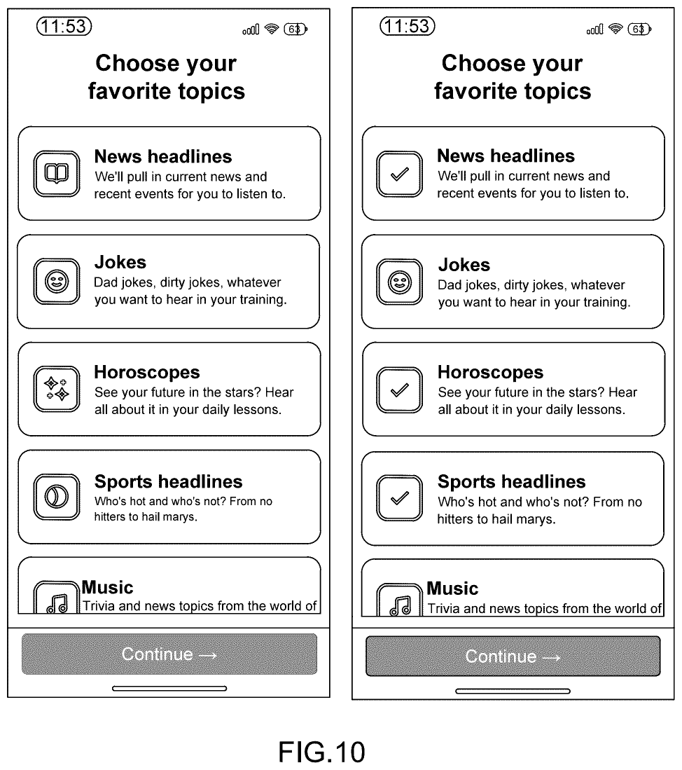

FIG. 10 illustrates user interface screens for choosing favorite topics in an auditory training application according to various embodiments. The interface screens demonstrate how users may personalize their training experience by selecting preferred content categories that align with individual interests and preferences, creating customized auditory training sessions that enhance engagement and motivation through personally meaningful content selection. The topic selection interface coordinates with the personalization module 218 to ensure that selected content preferences influence future training session content generation and delivery.

The topic selection screens display a menu of selectable content categories with descriptive text that explains the type of material users may encounter within each category, enabling informed decision-making about content preferences based on individual interests and engagement factors. Each topic category includes representative icons or visual elements that provide immediate recognition of content types while supporting users who may benefit from visual cues during navigation and selection processes.

The available content categories include news headlines, jokes, horoscopes, sports headlines, and music, each providing distinct types of auditory material that address different vocabulary domains, speaking styles, and contextual frameworks for speech comprehension training. The news headlines content category provides access to dynamic input text sources that comprise current news feeds, delivering timely and relevant information that changes regularly to maintain user interest and provide contemporary vocabulary exposure. The sports headlines category delivers current athletic competition results, player statistics, and sports-related news that incorporates specialized sports vocabulary and statistical information. The horoscopes category provides predictive language patterns and personality-related vocabulary that many users find familiar and engaging.

The interface screens display checkmark indicators for selected topics, providing immediate visual feedback about user preferences and content activation status that enables users to track their selection choices and modify preferences as needed during the personalization process. The selection status indicators coordinate with the personalization module 218 to ensure that user preferences are accurately captured and stored within user profiles for future training session customization.

The topic selection interface includes continue buttons that enable users to proceed with their selected preferences and initiate training sessions that incorporate chosen content categories.

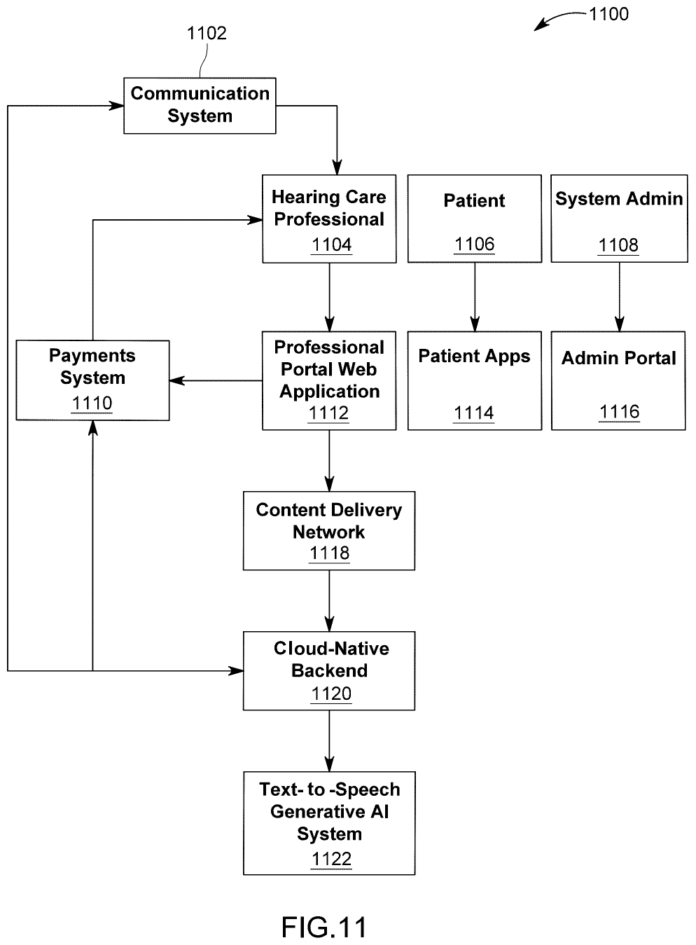

FIG. 11 illustrates a professional portal 1100 container diagram detailing the web application structure and supporting system interfaces according to various embodiments. The professional portal 1100 container diagram demonstrates how healthcare professionals interact with the auditory training platform through specialized web application interfaces that coordinate with external systems and supporting services to deliver comprehensive clinical functionality. The diagram presents the architectural relationships between user roles, application containers, and external service integrations that enable healthcare providers to manage patient 1106 care activities, monitor training progress, and coordinate clinical workflows.

The professional portal web application 1112 serves as the primary interface through which hearing care professionals 1104 access patient management functionality, progress monitoring capabilities, and administrative tools that support clinical practice operations and patient care coordination activities. The system administrator 1108 interacts with administrative functions and system configuration capabilities through specialized interfaces. The web application provides comprehensive patient billing capabilities that coordinate with external payments systems 1110 to process invoices, handle subscription management, and facilitate reimbursement activities. Patient progress tracking functionality enables healthcare professionals to monitor user performance metrics, assess improvement trajectories, and evaluate training effectiveness through detailed analytics and reporting capabilities.

The professional portal web application 1112 incorporates team member management features that allow healthcare organizations to coordinate staff access permissions, assign patient responsibilities, and manage user roles across different organizational levels. Support functionality provides healthcare professionals with technical assistance resources, troubleshooting guidance, and customer service access. Notification systems enable healthcare professionals to communicate with patients 1106, send training reminders, and deliver educational content through automated messaging capabilities. Reporting features generate detailed analytics summaries, performance assessments, and clinical outcome measurements that facilitate evidence-based treatment planning.

The diagram displays connections with external systems including communications systems 1102 that provide messaging infrastructure, patient apps 1114 that deliver training functionality to users, an admin portal 1116 that enables system administration capabilities, a content delivery network 1118 that manages distribution of training materials and system resources, and a cloud-native backend 1120 that provides underlying data management, user authentication, and service coordination capabilities that support professional portal functionality across different healthcare organizations. The system also incorporates a text-to-speech generative AI system 1122 that generates synthesized audio representations for training exercises and voice cloning capabilities.

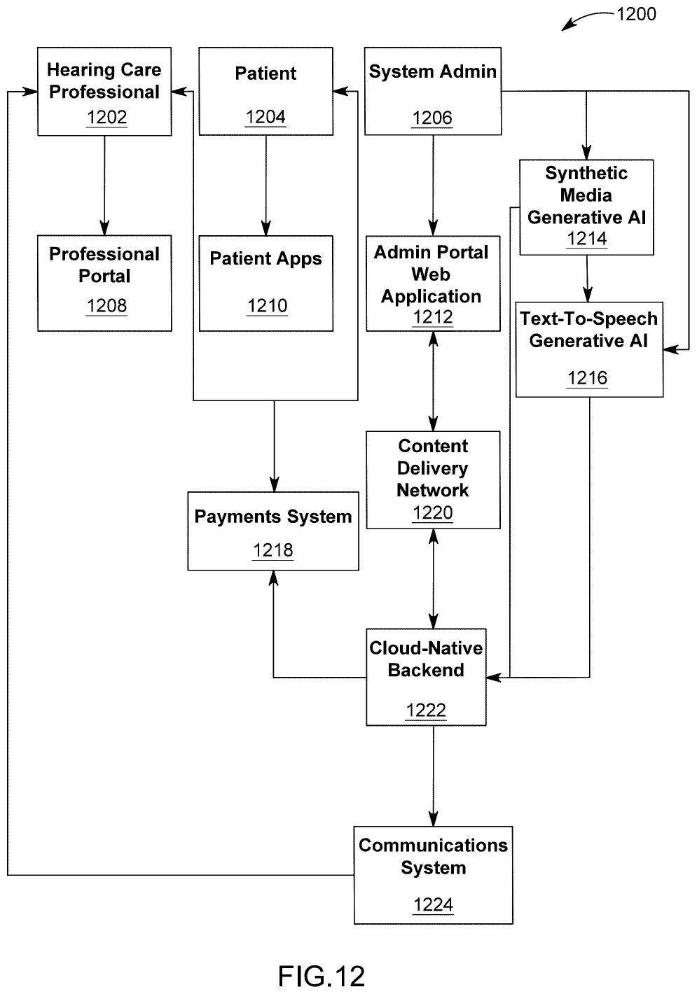

FIG. 12 illustrates an administrative portal container diagram showing the admin system components and their relationships according to various embodiments. The administrative portal container diagram demonstrates how system administrators interact with comprehensive management functionality through specialized web application interfaces that coordinate with artificial intelligence components and external service integrations to deliver scalable platform operations across multiple healthcare organizations and clinical practice environments.

The auditory training system 1200 includes three primary user roles: a hearing care professional 1202, a patient 1204, and a system administrator 1206, each interacting with different aspects of the system. The hearing care professional 1202 interfaces with a professional portal 1208 that provides access to clinical management features. The patient 1204 interacts with patient apps 1210 that deliver training functionality. The admin portal web application 1212 provides comprehensive practice creation capabilities that enable system administrators 1206 to establish new healthcare practice accounts within the platform infrastructure. Practice creation functionality involves the configuration of organizational hierarchies, administrative structures, and operational parameters that support independent clinical operations while maintaining centralized platform management. Clinic creation functionality enables administrators to configure individual clinic locations, facility-specific parameters, and operational characteristics that support localized service delivery within broader healthcare practice organizations.

Banding customization features provide administrators with comprehensive tools for configuring user access levels, service tier definitions, and feature availability parameters based on subscription arrangements, licensing agreements, and organizational service level requirements. Billing platform management tools provide administrators with comprehensive oversight capabilities for financial operations, subscription management, and revenue processing activities that support business operations across different organizational accounts. Revenue tracking capabilities enable administrators to monitor system usage patterns, financial performance metrics, and subscription utilization data that inform business development decisions and platform optimization strategies.

Content curation functionality allows administrators to manage training materials, exercise libraries, and educational resources that support auditory training program delivery across different user populations and clinical applications. Integration capabilities enable connectivity with third-party content providers, external exercise libraries, and specialized auditory training resources that expand available training materials.

The administrative portal displays connections with synthetic media generative AI 1214, text-to-speech generative AI 1216, and large language model generative AI integration capabilities that provide advanced artificial intelligence functionality for creating audiovisual content, managing voice synthesis capabilities, and coordinating natural language processing operations. The system also incorporates a payments system 1218 that handles financial transactions within the platform, a content delivery network 1220 that manages the distribution of training materials and system content, a cloud-native backend 1222 that provides the underlying infrastructure and data management capabilities that support the system's operations, and a communications system 1224 that enables interaction between the various components and users of the system.

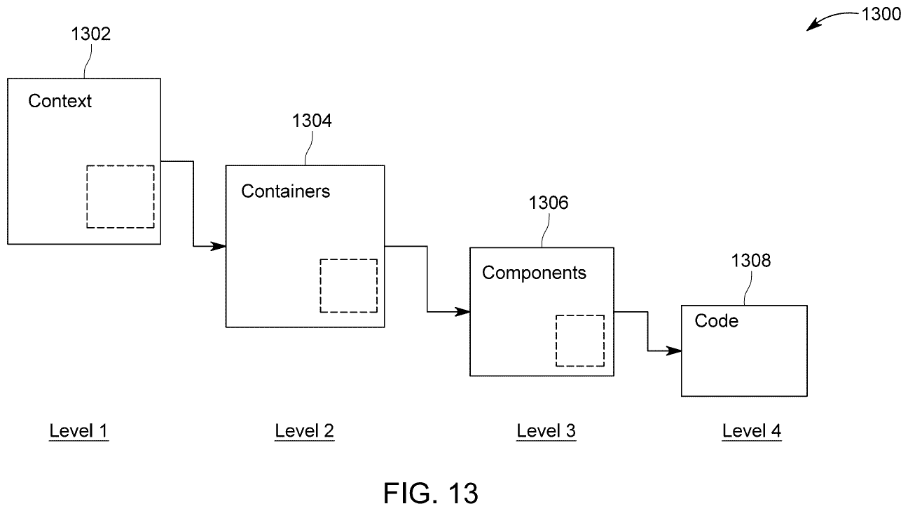

FIG. 13 illustrates an exemplary software architecture according to various embodiments. The software system 1300 provides a hierarchical approach to visualizing software system architecture through four distinct abstraction levels that enable comprehensive understanding of system structure and component relationships within the auditory training platform. The hierarchical structure enables architects, developers, and other technical professionals to navigate between different levels of system complexity while maintaining coherent understanding of overall system design and component interactions.

The context module 1302 represents the highest abstraction layer, providing a broad overview of the auditory training system and its interactions with external entities including users, external systems, and third-party services. The context module 1302 focuses on establishing the system boundary and identifying all external actors that interact with the auditory training platform while abstracting away internal implementation details.

The containers module 1304 provides the second abstraction layer, focusing on the major technological building blocks that comprise the system architecture including web applications, mobile applications, databases, and external service integrations. The containers module 1304 addresses technical architecture decisions, deployment considerations, and technology stack selections that influence system performance and scalability.

The components module 1306 represents the third abstraction layer, providing detailed views of the internal structure within individual containers and the relationships between major functional components including the text-to-speech module 214, personalization module 218, and dynamic adjustment module 220.

The code module 1308 provides the most detailed abstraction layer, focusing on implementation-specific details including class structures, interface definitions, and code-level relationships that realize the functionality described at higher abstraction levels.

The hierarchical relationships between different levels enable systematic decomposition of the complex auditory training system into manageable documentation units that address different stakeholder needs and technical perspectives.

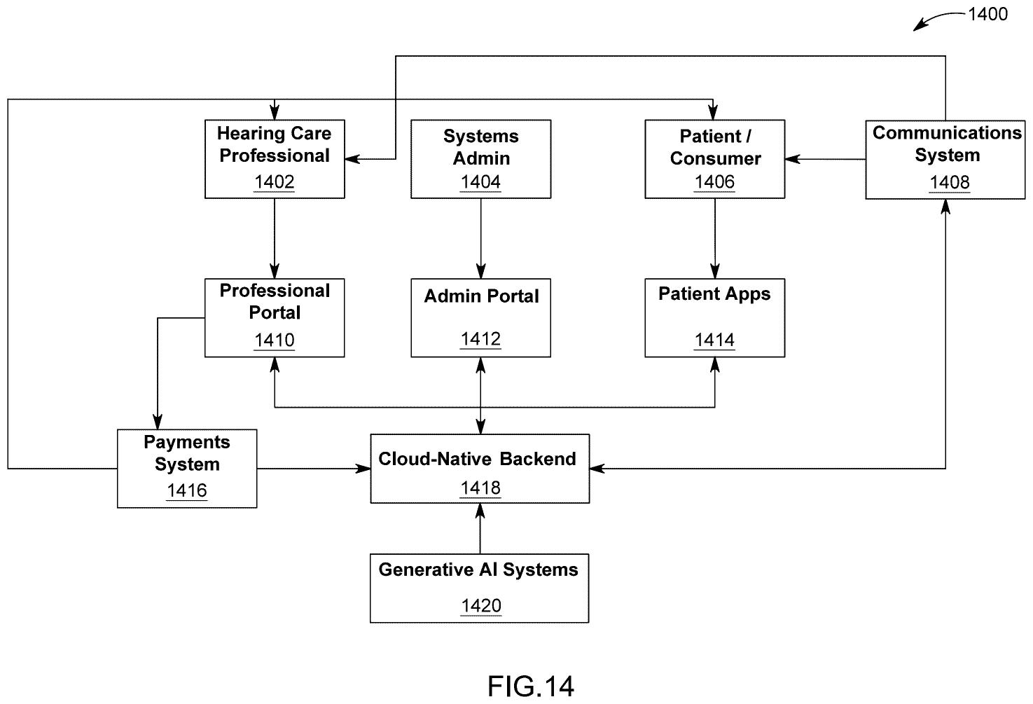

FIG. 14 illustrates a system context diagram showing the overall system interactions and architectural relationships between different user roles, system portals, and external service integrations according to various embodiments. The system architecture 1400 shows how the auditory training platform coordinates multiple user interfaces, external service dependencies, and technological components to provide functionality for hearing care professionals, system administrators, and patients or consumers. The diagram presents a high-level view of system boundaries and external relationships that establish the operational context for the personalized adaptive auditory training services disclosed herein.

The system context diagram displays three primary user roles that interact with the auditory training platform through specialized interfaces designed to address distinct functional requirements and operational responsibilities. Hearing care professionals 1402 access system functionality through the professional portal 1410 that supports clinical workflow management, patient monitoring, and professional service delivery activities. System administrators 1404 utilize the admin portal 1412 that enables platform configuration, organizational setup, and technical administration activities that support multi-tenant operations. Patients and consumers 1405 interact with the system through the patient apps 1406 that deliver personalized training experiences, progress tracking, and engagement features.

The professional portal 1410 provides comprehensive functionality for hearing care professionals including patient billing capabilities, patient progress tracking functionality, team member management features, support functionality, notification systems, and reporting features that generate detailed analytics summaries and clinical outcome measurements.

The admin portal 1412 provides administrative functionality for system management including practice creation capabilities, clinic creation functionality, banding customization features, billing platform management tools, revenue tracking capabilities, content curation functionality, and integration capabilities that enable connectivity with third-party content providers.

The patient apps 1414 provide user-facing functionality including localization support, theme customization capabilities, voice cloning functionality, training capabilities, assessment tools, progress indicators, content feed features, user settings functionality, appointment booking capabilities, sound therapy features, and notification systems.

The system context diagram displays connections between the three main portals and external systems including payments systems 1416, communications systems 1408, cloud native backend 1418, and generative AI systems 1420 that provide capabilities including voice synthesis, content generation, and adaptive personalization features.

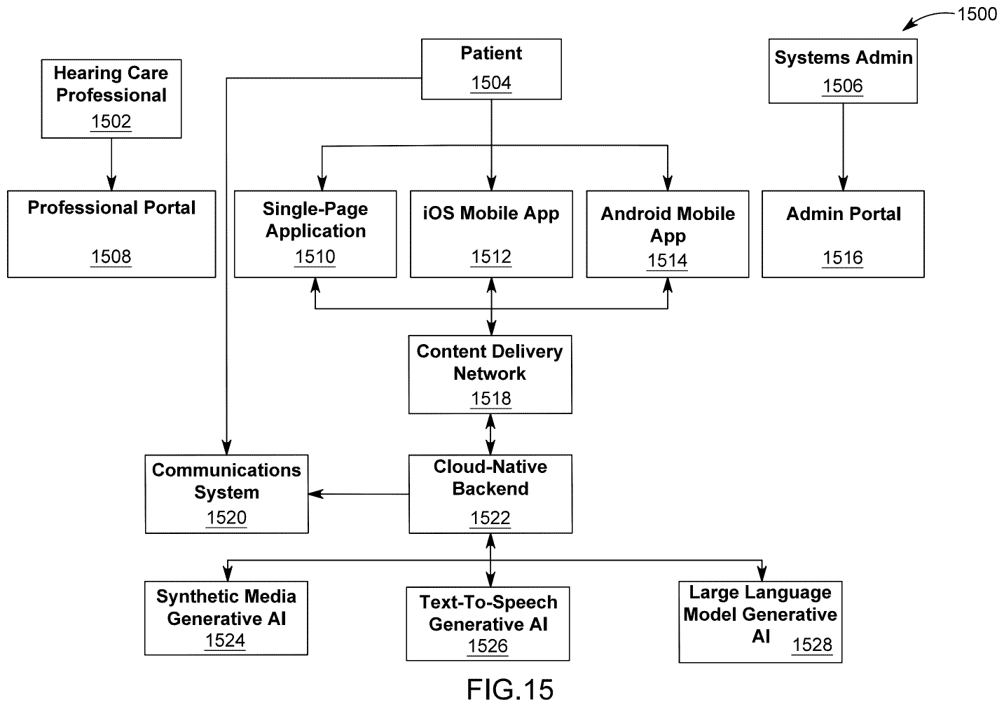

FIG. 15 is a patient apps container diagram according to an embodiment of the subject matter described herein. The component diagram demonstrates the architectural structure of patient-facing applications that deliver comprehensive auditory training functionality through web-based and mobile interfaces. The system includes three primary user roles: systems admin 1500, hearing care professional 1502, and patient 1504, each interacting with different aspects of the patient apps architecture. The single page web application architecture provides users with seamless access to personalized training experiences, assessment tools, and engagement features through responsive interface designs that accommodate various device types and screen configurations.

The patient apps module 212 interfaces with multiple system portals including admin portal 1506, professional portal 1508, and an additional admin portal 1516 that provide administrative and clinical management capabilities. The architecture incorporates a single page application 1510 that delivers web-based functionality, along with mobile app 1512 and android mobile app 1514 that provide platform-specific access for mobile users. The patient apps module 212 provides localization functionality that enables multi-language interface presentation and cultural customization options that address diverse user populations and international service delivery requirements. The localization capabilities include language translation services for interface elements, training content, and user communication features that accommodate users who prefer non-English language interactions during auditory training activities.

Theme customization capabilities allow users to personalize interface appearance characteristics including color schemes, visual presentation elements, and layout arrangements that optimize individual user experiences and accessibility requirements. The theme functionality provides users with multiple visual design options that accommodate different aesthetic preferences, visual comfort requirements, and accessibility considerations including high contrast modes, large text options, and color-blind friendly palettes.

Voice cloning functionality enables the creation of personalized audio experiences using familiar speaker voices that enhance user engagement and training effectiveness through emotionally meaningful content delivery. The voice cloning capabilities coordinate with the text speech generator 1524 to generate personalized synthesized audio representations that preserve speech characteristics unique to individual speakers including family members, friends, or other familiar voices.

Training functionality provides comprehensive exercise delivery systems that include various difficulty levels, adaptive challenge adjustments, and personalized content selection mechanisms that address individual user capabilities and rehabilitation objectives. The training capabilities coordinate with the cloud native backend 1522 to modify exercise parameters including speaking rates, background noise levels, phonetic complexity, and contextual support based on user performance patterns.

Assessment tools enable comprehensive performance evaluation, progress measurement, and skill development tracking that provides users and healthcare professionals with objective feedback about training effectiveness and improvement trajectories. Progress indicators provide visual feedback mechanisms including achievement recognition systems, milestone tracking displays, and gamification elements that maintain user motivation. The system incorporates supporting infrastructure including content delivery network 1518 that manages distribution of training materials and communications system 1520 that handles messaging and notifications between system components.

The patient apps module 212 integrates with multiple AI-powered components including the text speech generator 1524 to generate personalized synthesized audio representations, synthetic media generator 1526 that creates audiovisual content for training exercises, and language model generator 1528 to enable natural conversation with artificial intelligence systems, making auditory training more relatable and life-like through interactive cognitive therapy experiences that simulate realistic communication scenarios.

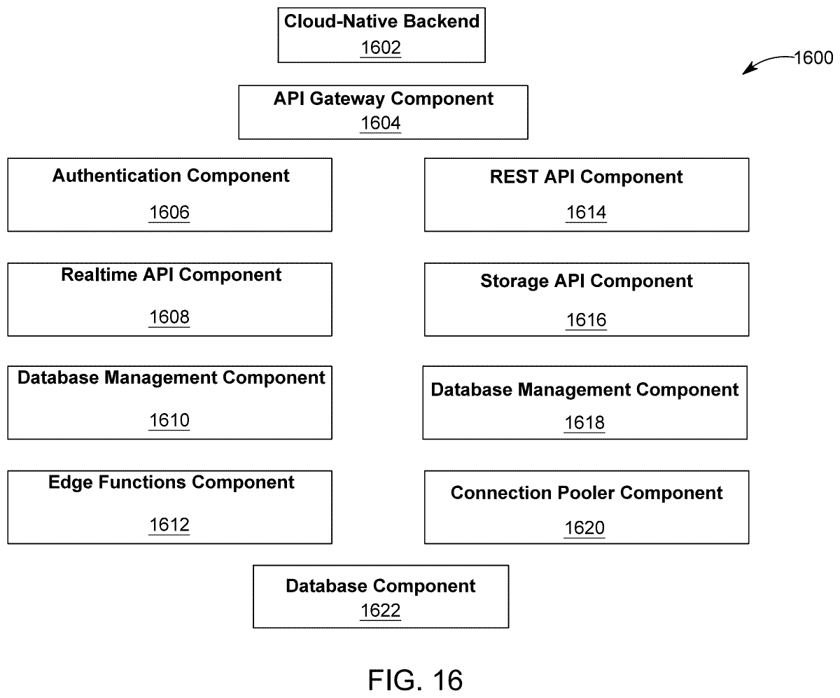

FIG. 16 illustrates a cloud-native backend component diagram showing the backend infrastructure according to various embodiments. The cloud-native backend 1602 architecture demonstrates how distributed computing resources and scalable service delivery mechanisms coordinate to provide personalized adaptive auditory training across multiple user interfaces and organizational contexts. The backend infrastructure incorporates containerized service architectures, microservice design patterns, and distributed data management systems that enable elastic scaling, fault tolerance, and high availability characteristics that accommodate varying user loads and service demand patterns.

The cloud-native backend 1600 container represents the overarching infrastructure framework that coordinates multiple service components and data management systems to deliver integrated platform functionality. The backend container architecture incorporates orchestration platforms, service mesh technologies, and distributed computing frameworks that enable coordinated service delivery across multiple computational resources and geographic locations. Container-based deployment approaches facilitate service isolation, resource allocation optimization, and independent scaling capabilities that enable different system components to operate efficiently while maintaining coordinated functionality delivery and data consistency.

The API gateway component 1604 serves as the central coordination point for managing external communication, request routing, and service orchestration activities that connect user-facing applications with backend service implementations. The API gateway functionality incorporates request authentication, authorization validation, and security enforcement mechanisms that protect backend services while enabling appropriate access control and user verification procedures. Load balancing capabilities within the API gateway distribute incoming requests across multiple service instances, optimize resource utilization patterns, and maintain service availability during periods of high demand or infrastructure maintenance activities.

The authorization component 1606 provides comprehensive identity management, access control, and permission validation services that coordinate with healthcare data security requirements and regulatory compliance frameworks. Authorization functionality incorporates role-based access control mechanisms, attribute-based permission systems, and dynamic authorization policies that enable fine-grained access management across different user types, organizational contexts, and functional areas within the auditory training platform. The realtime API component 1608 enables real-time data synchronization and live updates between client applications and backend services, supporting interactive features such as live training session monitoring and immediate performance feedback delivery.

The REST API component 1614 provides standardized communication interfaces that enable structured data exchange between user-facing applications and backend service implementations through HTTP-based request and response patterns. REST API functionality incorporates resource-oriented design principles, stateless communication protocols, and standardized data formats that facilitate integration with diverse client applications and third-party service providers while maintaining consistent interface contracts and data exchange patterns.

The pipeline API component provides specialized interfaces for managing data processing workflows, batch operations, and asynchronous task execution that support complex computational requirements including voice synthesis, audio processing, and machine learning model operations. Pipeline functionality coordinates with distributed computing resources, task scheduling systems, and workflow orchestration platforms that enable efficient processing of computationally intensive operations while maintaining system responsiveness and resource optimization characteristics.

The storage API component 1616 provides comprehensive data management interfaces that coordinate with distributed storage systems, backup procedures, and data replication mechanisms to ensure reliable data persistence and retrieval capabilities across the platform infrastructure. Storage functionality incorporates object storage systems, file management capabilities, and metadata indexing services that enable efficient storage and retrieval of various data types including audio files, user profiles, training content, and performance analytics data.

The database management component 1610 coordinates with relational database systems to provide structured data storage, transaction management, and query processing capabilities that support complex data relationships and analytical operations across the auditory training platform. Database functionality incorporates PostgreSQL database systems that provide extensible relational data management, full-text search capabilities, and advanced indexing features that enable efficient data storage and retrieval operations. An additional database management component 1618 provides supplementary database coordination capabilities that work in conjunction with the primary database management functions.

The platform management component provides comprehensive administrative interfaces and operational oversight capabilities that enable system configuration, monitoring, and maintenance activities across the distributed backend infrastructure. The edge functions component 1612 provides distributed computing capabilities that enable code execution closer to user locations, reducing latency and improving response times for time-sensitive operations including real-time audio processing and interactive training features. The connection pooler component 1620 manages database connection resources by maintaining pools of reusable database connections that optimize performance and resource utilization. The database component 1622 represents the underlying database infrastructure that stores and manages all persistent data for the auditory training platform.

The system may be implemented using a backend platform such as Supabase that leverages PostgreSQL to deliver services for web and mobile application development with real-time capabilities. Supabase integration provides comprehensive backend-as-a-service functionality that combines PostgreSQL database capabilities with real-time synchronization features, authentication services, and API generation capabilities that streamline platform development and deployment activities.

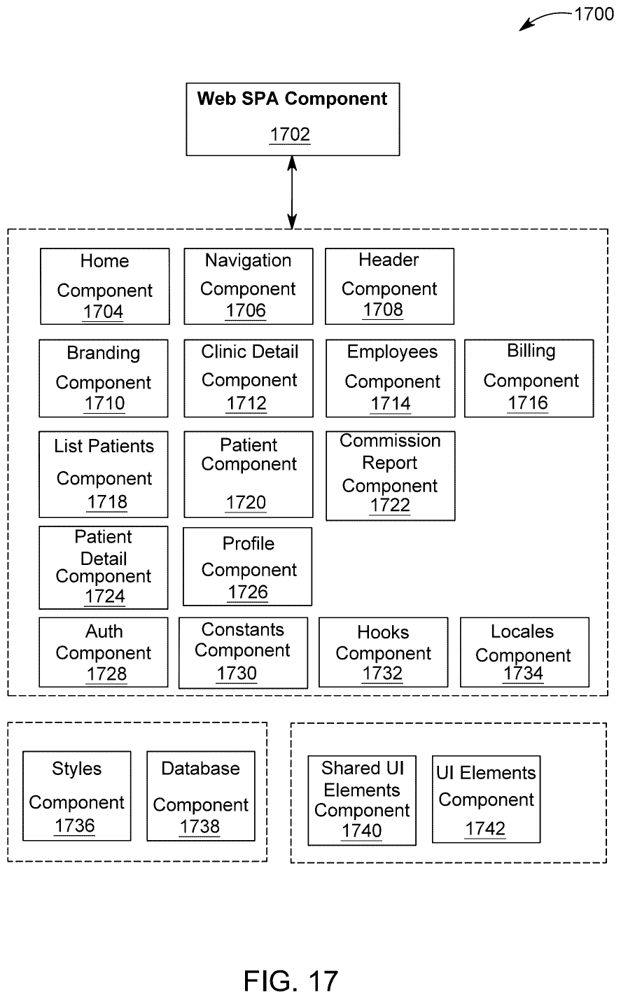

FIG. 17 illustrates a single page web app component diagram according to an embodiment of the subject matter described herein. The web application system 1700 includes a Web SPA Component 1702 that coordinates with multiple supporting components organized in functional groupings. The single page web application architecture provides users with seamless access to personalized training experiences through responsive interface designs that accommodate various device types and screen configurations. The component organization reflects modular development approaches that enable efficient code maintenance, feature updates, and cross-platform compatibility across different technological environments.

The Web SPA Component 1702 connects to several core interface components including a Home Component 1704, Navigation Component 1706, and Header Component 1708. Additional interface elements include a Branding Component 1710, Clinic Detail Component 1712, Employees Component 1714, and Billing Component 1716. The web application implements responsive design principles that optimize visual presentation and interaction patterns across different screen sizes and device orientations while maintaining consistent functionality access. The architecture enables real-time data synchronization, immediate user interface updates, and interactive training experiences through modern web technologies including WebSocket connections and progressive web application capabilities.

The system includes patient management functionality through the List Patients Component 1718, Patient Component 1720, Commission Report Component 1722, and Patient Detail Component 1724. User management is handled through the Profile Component 1726. The single page application 1700 coordinates with the patient apps module 212 to deliver comprehensive auditory training functionality including exercise delivery, progress tracking, and user interaction management through streamlined interface designs that minimize page loading times and provide smooth navigation experiences. The web application architecture supports offline functionality capabilities that enable continued training participation during periods of limited connectivity while maintaining data integrity and synchronization capabilities when network access becomes available.

System infrastructure components include an Auth Component 1728, Constants Component 1730, Hooks Component 1732, and Locales Component 1734. These are organized alongside a Styles Component 1736 and Database Component 1738. The interface framework includes a Shared UI Elements Component 1740 and UI Elements Component 1742 that provide standardized visual elements and interaction patterns across the application. The application implements accessibility features including keyboard navigation support, screen reader compatibility, and visual accommodation options that ensure inclusive user experiences across diverse user populations and assistive technology requirements.

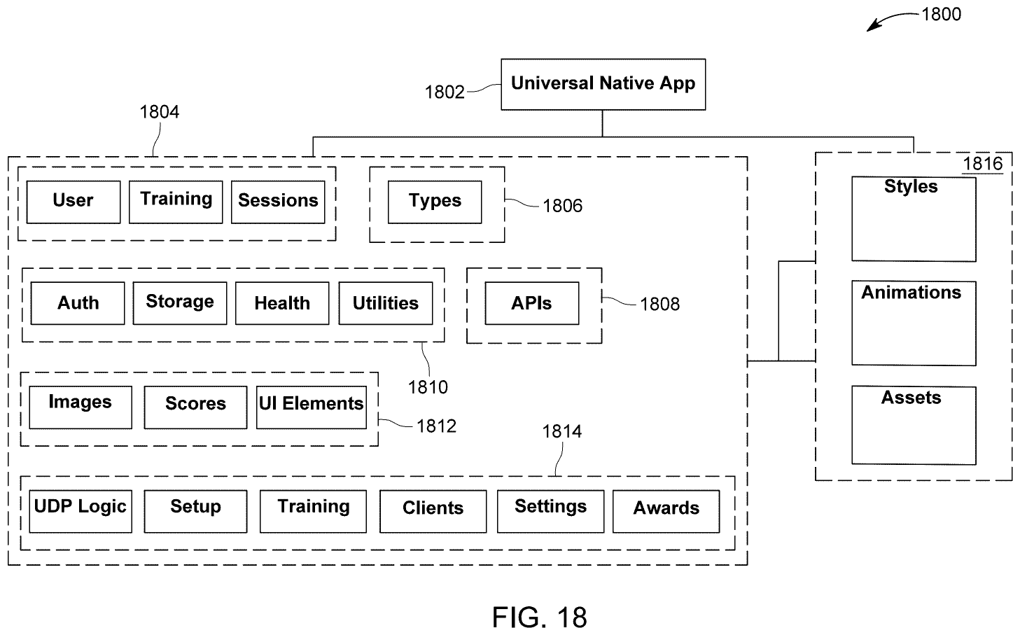

FIG. 18 illustrates a universal native app component diagram 1800 according to various embodiments. The universal native app 1802 architecture enables cross-platform application development and deployment across web, iOS, and Android environments through unified codebase management and shared functionality implementation. The component architecture supports comprehensive auditory training functionality delivery through native application interfaces while maintaining code efficiency and development consistency across different technological platforms and device configurations.

The universal native app 1802 implements platform-specific optimizations including native audio processing frameworks, device-specific user interface adaptations, and operating system integration capabilities that ensure optimal performance characteristics on each target environment. The architecture facilitates code reuse patterns that minimize development overhead while ensuring platform-specific optimization and native performance characteristics. Cross-platform compatibility involves the implementation of abstraction layers that handle platform-specific interface conventions, device capabilities, and operating system integration requirements while maintaining unified business logic and functionality implementation.

Authentication and security components provide comprehensive user verification and data protection capabilities that align with healthcare data security requirements while maintaining seamless user access experiences across different platform implementations. The native app 1802 coordinates with authentication systems including biometric authentication, secure storage mechanisms, and encrypted communication protocols that protect user health information and training data across multiple device types and operating systems.

User interface components incorporate responsive design principles and adaptive layout systems that optimize visual presentation and interaction patterns across different screen sizes, device orientations, and platform-specific interface conventions. The UI elements container 1812 architecture enables consistent visual branding and user experience delivery while accommodating platform-specific design guidelines, interaction paradigms, and native accessibility frameworks that vary between web browsers, iOS applications, and Android implementations.

Data management components provide comprehensive information storage, synchronization, and offline capability features that ensure consistent user experiences and data availability across different platform implementations and network connectivity conditions. The application implements offline functionality, local data storage, and background processing capabilities that enable continued training participation regardless of network connectivity status. Training exercise delivery components coordinate with audio processing systems, user interaction mechanisms, and performance assessment tools to provide comprehensive auditory training experiences across different platform implementations.

The universal architecture supports platform-specific features including push notifications, device-specific audio routing, and real-time synchronization protocols. The user sessions container 1804 handles user authentication state, session management, and persistent login capabilities that maintain secure access across application restarts and device changes. The types container 1806 provides type definitions and data structure specifications that ensure consistent data handling and interface contracts across different platform implementations. The utilities container 1810 contains shared helper functions, common algorithms, and reusable code components that support various application features while maintaining code efficiency and consistency. The settings container 1814 manages user preferences, application configuration options, and platform-specific customization features that enable personalized user experiences. The styles animations assets container 1816 manages visual elements, animations, and static resources that provide consistent branding and interactive feedback across all platform implementations. The styles animations assets container 1816 coordinates visual styling, theme management, and responsive design implementations that adapt to different screen sizes and platform conventions. The universal native app 1802 integrates with the broader auditory training platform through secure APIs container 1808 that maintain functional consistency across different platform implementations.

It should be understood that the invention can be implemented in various manners, including as a process, an apparatus, a system, a device, a method, or a computer readable medium such as a computer readable storage medium or a computer network wherein program instructions are sent over optical or electronic communication lines. The invention may take the form of an entirely hardware embodiment, an entirely software embodiment (including firmware, resident software, micro-code, etc.) or an embodiment combining software and hardware aspects that are particularly suited for adaptive auditory training applications. Furthermore, the invention may take the form of a computer program product on a computer-usable storage medium having computer-usable program code embodied in the medium. Any suitable computer readable medium may be utilized including hard disks, CD-ROMs, optical storage devices, magnetic storage devices, solid-state drives, cloud storage systems, or any other physical or digital storage medium capable of storing audio processing algorithms and voice synthesis models.

Computer program code for carrying out operations of the invention may be written in an object oriented programming language such as Java, Smalltalk, C++, Python, or the like. However, the computer program code for carrying out operations of the invention may also be written in conventional procedural programming languages, such as the “C” programming language, JavaScript, or similar programming languages suitable for real-time audio processing and machine learning implementations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider) to enable cloud-based voice synthesis and adaptive difficulty adjustment processing.

The software implementations described herein may utilize various artificial intelligence frameworks, neural network libraries, and audio processing toolkits including but not limited to TensorFlow, PyTorch, or similar machine learning platforms for implementing voice cloning and speech synthesis functionality. The system may be deployed across distributed computing environments including containerized architectures, microservices platforms, and cloud-native backends that support scalable auditory training delivery across multiple user interfaces and organizational contexts.

What is claimed is:

1. A computer-implemented method of performing adaptive auditory training, comprising:
generating a synthesized audio representation of an input text;
presenting the synthesized audio representation to a first user during an auditory training session;
receiving audio input from the first user corresponding to the input text; and
dynamically adjusting a difficulty of the synthesized audio representation based on quantitative performance metrics derived from the received audio input to maintain training difficulty within target performance parameters, wherein adjusting the difficulty of the synthesized audio representation occurs between consecutive prompts during a same training session.

2. The method of claim 1, further comprising personalizing the synthesized audio representation by training an artificial intelligence model on voice samples of a second user to create a voice clone of the second user that preserves speech characteristics of the second user, wherein the synthesized audio representation is emotion-agnostic with neutral prosody.

3. The method of claim 1, wherein adjusting the difficulty of the synthesized audio representation includes modifying audio parameters including at least one of a time between words, a background noise level, a similarity between neighboring words, a number of syllables in words, a pitch of words, and a number of context clues.

4. The method of claim 1, wherein the quantitative performance metrics include at least one of QuickSIN SNR loss measurements, response latency data, signal-to-noise ratio measurements response accuracy ranges, and machine learning-generated performance scores.

5. The method of claim 1, wherein dynamically adjusting the difficulty further comprises:
evaluating user response accuracy after each prompt;
calculating acoustic threshold parameters using a psychometric staircase algorithm;
selecting a next training stimulus based on the psychometric staircase calculations; and
implementing the selected stimulus before presenting a next prompt.

6. The method of claim 1, wherein the input text is received from an interactive input text source comprising a chat session with an artificial intelligence chatbot.

7. The method of claim 1, wherein the input text is received from a dynamic input text source comprising at least one of a news feed and biblical passages.

8. The method of claim 1, further comprising generating, based on the dynamically adjusted difficulty synthesized audio representation, at least one of an audiology diagnostic and an actionable insight for providers in audiology and speech pathology.

9. The method of claim 1, wherein dynamically adjusting the difficulty of the synthesized audio representation comprises increasing a background noise level to simulate real-world listening environments.

10. The method of claim 1, wherein presenting the synthesized audio representation includes combining a first audio stream comprising the synthesized audio representation with a first audio stream comprising generic background noise stored in a pre-curated noise library.

11. A system, comprising:
a processing unit;
a memory operatively coupled to the processing unit, the memory storing;
a text-to-speech module operable to generate a synthesized audio representation of an input text;
a dynamic adjustment module operable to dynamically adjust a difficulty of the synthesized audio representation based on quantitative performance metrics derived from the received audio input to maintain training difficulty within target performance parameters, wherein adjusting the difficulty of the synthesized audio representation occurs between consecutive prompts during a same training session; and
a patient apps module operable to present the synthesized audio representation to a first user and receive audio input from the first user corresponding to the input text.

12. The system of claim 11, further comprising a personalization module operable to personalize the synthesized audio representation by training an artificial intelligence model on voice samples of a second user to create a voice clone of the second user that preserves speech characteristics of the second user, wherein the synthesized audio representation is emotion-agnostic with neutral prosody.

13. The system of claim 11, wherein adjusting the difficulty of the synthesized audio representation includes modifying audio parameters including at least one of a time between words, a background noise level, a similarity between neighboring words, a number of syllables in words, a pitch of words, and a number of context clues.

14. The system of claim 11, wherein the quantitative performance metrics include at least one of QuickSIN SNR loss measurements, response latency data, signal-to-noise ratio measurements response accuracy ranges, and machine learning-generated performance scores.

15. The system of claim 11, wherein the dynamic adjustment module is operable to:
evaluate user response accuracy after each prompt;
calculate acoustic threshold parameters using psychometric staircase algorithms;
select a next training stimulus based on the psychometric staircase calculations; and
implement the selected stimulus before presenting the next prompt.

16. The system of claim 11, wherein the input text is received from an interactive input text source comprising a chat session with an artificial intelligence chatbot.

17. The system of claim 11, wherein the input text is received from a dynamic input text source comprising at least one of a news feed and biblical passages.

18. The system of claim 11, wherein the dynamic adjustment module is operable to generate, based on the dynamically adjusted difficulty synthesized audio representation, at least one of an audiology diagnostic and an actionable insight for providers in audiology and speech pathology.

19. The system of claim 11, wherein dynamically adjusting the difficulty of the synthesized audio representation comprises increasing a background noise level to simulate real-world listening environments.

20. The system of claim 11, wherein the patient apps module is operable to present the synthesized audio representation to the first user by combining a first audio stream comprising the synthesized audio representation with a second audio stream comprising generic background noise stored in a pre-curated noise library.
